(19) United States
(12) Patent Application Publication
(10) Pub. No.: US 2010/0164461 A1
(43) Pub. Date: Jul. 1, 2010

(54) REFERENCE VOLTAGE GENERATION CIRCUIT

(76) Inventors: Tetsuya Hirose, Sapporo-shi (JP); Tetsuya Asai, Sapporo-shi (JP); Yoshihito Amemiya, Sapporo-shi (JP); Kenichi Ueno, Sapporo-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 12/670,199

(22) PCT Filed: Jul. 16, 2008
(86) PCT No.: PCT/JP2008/062830

§ 371 Date: Feb. 24, 2010

(30) Foreign Application Priority Data
Jul. 23, 2007 (JP) 2007-191106

(51) Int. Cl. G05F 1/10

(52) U.S. Cl. 323/285

(57) ABSTRACT

An object of the present invention is to generate a reference voltage that is stable in relation to manufacturing process variations, by matching the operating regions of the MOSFETs contributing to generation of the reference voltage. The reference voltage generation circuit 1 includes: a current mirror unit 2 that generates a current I_{P} at current output terminals P_{C1} to P_{C5}; a MOSFET 6b having a drain terminal connected to the current output terminal P_{C2} side, a source terminal connected to ground side, and a gate terminal connected to a reference voltage output terminal P_{OUT}; a combined voltage generating unit 8 having two MOSFET pairs in which currents are generated at drain terminals from the current output terminals P_{C3} to P_{C5}, source terminals are mutually connected, and a combined voltage with a positive temperature coefficient is generated; and a MOSFET 9 in which current is generated at a drain terminal from the current mirror unit 2, a gate terminal is connected to the input of the combined voltage generating unit 8, a source terminal is connected to the ground side, and a voltage with a negative temperature coefficient is generated.

### TECHNICAL FIELD

The present invention relates to a reference voltage generation circuit that supplies a constant reference voltage.

### BACKGROUND ART

In the past, reference voltage generation circuits have been used as circuits for generating a reference voltage in circuits of AD converters, DA converters, op-amps, and regulators. These reference voltage generation circuits are generally known for outputting a reference voltage by referring to the silicon bandgap energy created by combining a bipolar transistor element or diode element with resistance. With such a reference voltage generation circuit, however, because an element other than a MOSFET is needed when it is configured on a Large Scale Integrated (LSI) circuit, the number of steps in the production process increases, and therefore operational matching tends to become very difficult. In addition, there arises a problem that power consumption tends to be relatively large, and the chip surface area must be increased to assure high resistance even in cases of operation at a low current.

To overcome these problems Non-patent Document 1 below has proposed a reference voltage generation circuit constructed only from MOSFETs without using a bipolar element and resistor element. This reference voltage generation circuit is one that generates a reference voltage by referring to the threshold voltage in the MOSFETs at the absolute zero temperature. More specifically, the circuit comprises a MOSFET that operates in the strong inversion-linear region in place of resistance, and also a MOSFET that operates in the strong inversion-saturation region, which generates the bias voltage of that MOSFET. The scaling in reference to the thermal voltage by the β multiplier referenced self-biasing circuit, and the equalized currents flowing through each current path of the circuit allow the MOSFET operating in the strong inversion-linear region to add the threshold voltage and the scaled voltage by thermal voltage to the output voltage and to output the same. A reference voltage generation circuit of such a configuration enables a circuit outputting a reference voltage with little fluctuation due to temperature to be constructed on an LSI.

Non-patent Document 1: T. MATSUDA, R. MINAMI, A. KANAMORI, H. IWATA, T. OHZONE, S. YAMAMOTO, T. IHARA, S. NAKAJIMA, “A Temperature and Supply Voltage Independent CMOS Voltage Reference Circuit”, MICE TRANS. ELECTRON., Vol. E88-C, No. 5, pp. 1087-1093, May 2005.

### DISCLOSURE OF INVENTION

### Problems to be Solved by the Invention

However, the prior art reference voltage generation circuit discussed above operates so that the reference voltage is generated using MOSFETs with two different operating regions, and therefore mismatches occur in the operating parameters such as threshold voltage and carrier mobility, etc. In addition, the properties between the two MOSFETs change greatly in accordance with circuit design parameters, and stable reference voltage generation can be difficult to obtain. Furthermore, because the generated reference voltage fluctuates in accordance with the currents generated in the plurality of circuit paths of the current mirror circuit, maintaining a constant reference voltage has been extremely difficult because of the effect of fluctuation in the power supply voltage, etc.

Therefore, with the foregoing in view, an object of the present invention is to provide a reference voltage generation circuit capable of generating a reference voltage that is stable with respect to process variations during manufacturing by matching the operating regions of the MOSFETs contributing to generation of the reference voltage.

### Means for Solving the Problems

To solve the above problems, the reference voltage generation circuit of the present invention comprises: a current mirror unit supplied with a source voltage and generating a current at first to Nth (wherein N is an integer of 4 or more) current output terminals; a first field effect transistor operating as a linear resistance, and having a drain terminal connected to the second current output terminal side, a source terminal connected to ground side, and a gate terminal connected to a reference voltage output terminal; a combined voltage generating unit having one or more field effect transistor pairs in which currents are generated at drain terminals from any of the third to Nth current output terminals, source terminals are mutually connected, and a combined voltage with a positive temperature coefficient is generated between gate terminals, the field effect transistor pairs being connected in series between an input terminal and the reference voltage output terminal; and a second field effect transistor in which current is generated at a drain terminal from the third current output terminal, a gate terminal is connected to the input terminal of the combined voltage generating unit, a source terminal is connected on the ground side, and a voltage with a negative temperature coefficient is generated between the gate terminal and source terminal.

In accordance with such a reference voltage generation circuit, at each of the N current output terminals of the current mirror unit, a current is established that is determined by the circuit properties of the current mirror unit, the reference voltage output value, and the properties of the first field effect transistor operating as linear resistance, and due to the fact that the current is generated at the drain terminal of the field effect transistor pair of the combined voltage generating unit from the third to Nth current output terminals a combined voltage with a positive temperature coefficient is output between the input terminal of the combined voltage generating unit and the reference voltage output terminal. In addition, by generating a current from the third current output terminal to the drain terminal of the second field effect transistor, a voltage having negative temperature properties is output between the drain terminal and source terminal of the second field effect transistor. As a result, it is possible to output a constant voltage independent of temperature to the reference voltage output terminal by adjusting the circuit design parameters such as the aspect ratio, etc. of each field effect transistor. At that time, because the field effect transistor pair contributing to generation of the reference voltage and the second field effect transistor operate in the same operating region, a mismatch in operation parameters is unlikely to occur, and because the properties between field effect transistors do not fluctuate greatly in relation to design parameters, it is possible to generate a reference voltage that is stable with respect to temperature fluctuations. Additionally, it is possible to generate a stable reference voltage even if the output current of the current mirror unit fluctuates due to fluctuations in the power supply voltage, etc.

### EFFECT OF THE INVENTION

In accordance with the reference voltage generation circuit of the present invention, it is possible to generate a reference voltage that is stable with respect to variations in the manufacturing process by matching up the operating regions of the MOSFETs contributing to generation of the reference voltage.

### BRIEF DESCRIPTION OF DRAWINGS

FIG. 1 is a circuit diagram showing the reference voltage generation circuit of a preferred embodiment of the present invention;

FIG. 2 is a graph showing simulation results of temperature properties of the reference voltage generated by the reference voltage generation circuit of FIG. 1;

FIG. 3 is a graph showing the results of a source voltage-dependent simulation of the reference voltage generated by the reference voltage generation circuit of FIG. 1;

FIG. 4 is a graph showing the results of a temperature property simulation of the reference voltage generated by the reference voltage generation circuit of FIG. 1 when variations due to transistor process variations are taken into consideration;

FIG. 5 is a circuit diagram showing the reference voltage generation circuit of a modified example of the present invention;

FIG. 6 is a circuit diagram showing the reference voltage generation circuit of a different modified example of the present invention;

FIG. 7 is a graph showing the results of measurement of temperature properties of the reference voltage generated by the reference voltage generation circuit of FIG. 6;

FIG. 8 is a circuit diagram showing a three-terminal regulator circuit of the application example of the present invention; and

FIG. 9 is a circuit diagram showing a prior art example of a reference voltage generation circuit.

### EXPLANATION OF REFERENCE NUMERALS

1, 101, 201 . . . reference voltage generation circuit, 2, 102 . . . current mirror unit, 8, 108 . . . combined voltage generating unit, 6b . . . first MOSFET, 9 . . . second MOSFET, 10 . . . third MOSFET, P_{C1}, P_{C2}, P_{C3}, P_{C4}, P_{C5} . . . current output terminals, P_{IN} . . . input terminal, P_{OUT} . . . reference voltage output terminal, V_{DD} . . . power supply voltage, V_{REF} . . . reference voltage.

### BEST MODE FOR CARRYING OUT THE INVENTION

A preferred embodiment of the reference voltage generation circuit of the present invention is described in detail below with reference to the drawings. In the explanation of the drawings identical reference numbers refer to identical or corresponding parts, and duplicate explanations are omitted.

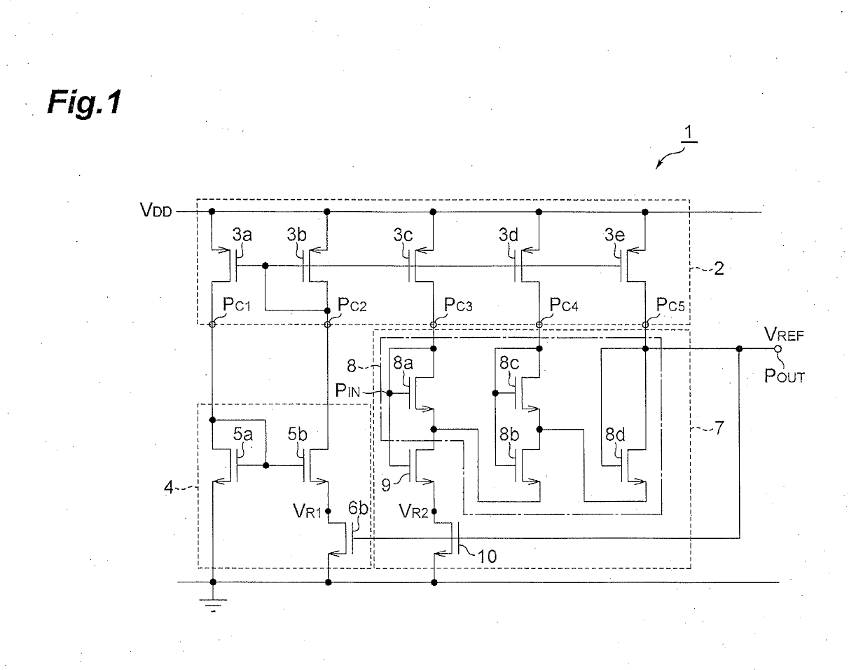

FIG. 1 is a circuit diagram showing the reference voltage generation circuit 1 of a preferred embodiment of the present invention. The reference voltage generation circuit 1 is the power supply circuit generating a reference voltage comprising MOS type field effect transistors (MOSFET) formed on an LSI.

As shown in the drawing, the reference voltage generation circuit 1 has a current mirror unit 2 that generates a current at five current output terminals P_{C1}, P_{C2}, P_{C3}, P_{C4}, P_{C5}. The current mirror unit 2 consists of five identically sized (channel length, channel width) P-type MOSFETs 3a, 3b, 3c, 3d, 3e. A power supply voltage V_{DD} is provided to the source terminal of each MOSFET 3a, 3b, 3c, 3d, 3e, and a gate terminal is commonly connected to the drain terminal of MOSFET 3b. In addition, the drain terminal of each MOSFET 3a, 3b, 3c, 3d, 3e is connected, respectively, to current output terminals P_{C1}, P_{C2}, P_{C3}, P_{C4}, P_{C5}. Such a reference voltage generation circuit 1 provides an essentially equivalent, constant current I_{P} to each of the five current output terminals P_{C1}, P_{C2}, P_{C3}, P_{C4}, P_{C5}.

A current source circuit unit 4 that draws current from the current mirror unit 2 is connected to the first current output terminal P_{C1} and the second current output terminal P_{C2} of the current mirror unit 2, and this current source circuit unit 4 contains three N-type MOSFETs 5a, 5b, and 6b. The drain terminals of MOSFETs 5a and 5b are connected to the first current output terminal P_{C1} and the second current output terminal P_{C2}, respectively, and the respective gate terminals thereof are commonly connected to the drain terminal of MOSFET 5a. The source terminal of MOSFET 5a is connected to ground. Additionally, the drain terminal of MOSFET 6b, which operates as linear resistance, is connected to the second current output terminal P_{C2} via MOSFET 5b by connecting it to the source terminal of MOSFET 5b, the source terminal thereof is connected to ground, and the gate terminal thereof is connected to the reference voltage output terminal P_{OUT}. The reference voltage output terminal P_{OUT} is the output terminal for obtaining the final reference voltage from the reference voltage generation circuit 1.

In a current source circuit unit 4 with the above configuration, the power supply voltage V_{DD} and the size of each FET are set so that MOSFETs 5a, 5b operate in the subthreshold region on the gate to source voltage and operate in the saturation region on the drain to source voltage (hereinafter, called “subthreshold-saturation region”). On the other hand, in MOSFET 6b they are established so that MOSFET 6b operates in the strong inversion region on the gate to source voltage and operates in the linear region on the drain to source voltage (hereinafter, called “strong inversion-linear region”). The current source circuit 4 operates so that a current I_{P} determined by the properties of transistors 5a, 5b, and 6b will be drawn from the first current output terminal P_{C1} and the second current output terminal P_{C2} of the current mirror unit 2.

In this case the current-voltage characteristics of the MOSFET in the strong inversion-linear region are expressed by Formula (1) below.

$$\begin{matrix}[ Mathematical Formula 1 ] & \\ {I}_{D} = {K}_{β} β ( {V}_{GS} - {V}_{TH} ) {V}_{DS} - \frac{1}{2} {V}_{DS}^{2} & ( 1 )\end{matrix}$$

In this case, I_{D} represents the drain current, K_{β}β represents the current gain coefficient, K_{β} represents the MOSFET aspect ratio W (channel width/L (channel length)), V_{GS} represents the gate-source voltage, V_{TH} represents the threshold voltage, and V_{DS} represents the drain-source voltage. In particular, when V_{DS} is sufficiently small, the higher-order term of V_{DS} can be ignored, and Formula (1) is approximated by Formula (2) below.

[Mathematical Formula 2]

I_{D}K_{β}β(V_{GS}−V_{TH})V_{DS} (2)

On the other hand, the current-voltage characteristics of the MOSFETs in the subthreshold region are represented by Formula (3) below.

$$\begin{matrix}[ Mathematical Formula 3 ] & \\ {I}_{D} = {KI}_{0} exp ( \frac{{V}_{GS} - {V}_{TH}}{η {V}_{T}} ) ( 1 - exp ( - \frac{{V}_{DS}}{{V}_{T}} ) ) , \\ {I}_{0} = μ {C}_{OX} {V}_{T}^{2} ( η - 1 ) & ( 3 )\end{matrix}$$

In this case, K represents the FET aspect ratio (=W (channel width)/L (channel length)), Iₒ represents the subthreshold current pre-coefficient, V_{T} (=k_{B}T/q) represents the thermal voltage, k_{B} represents the Boltzmann constant, T represents absolute temperature, q represents elementary charge, η represents the subthreshold slope coefficient, μ represents mobility, and C_{OX} represents capacity per unit area of the oxide film. The subthreshold current I_{D} becomes independent of the drain to source voltage V_{DS} in a saturation region having a drain voltage of 4×V_{T} (˜0.1 V) or more, and is calculated by Formula (4) below.

$$\begin{matrix}[ Mathematical Formula 4 ] & \\ {I}_{D} = {KI}_{0} exp ( \frac{{V}_{GS} - {V}_{TH}}{η {V}_{T}} ) & ( 4 )\end{matrix}$$

Because from the above formula the difference in gate to source voltage of MOSFETs 5a and 5b becomes the drain voltage V_{R1} of MOSFET 6b, which operates in the strong inversion-linear region, V_{R1} becomes Formula (5) below.

$$\begin{matrix}[ Mathematical Formula 5 ] & \\ {V}_{R 1} = {V}_{GS 1} - {V}_{GS 2} = η {V}_{T} ln ( \frac{{K}_{2}}{{K}_{1}} ) & ( 5 )\end{matrix}$$

Therefore, based on the properties of MOSFET 6b, the current I_{P} generated by the current mirror unit 2 is represented by Formula (6) below.

$$\begin{matrix}[ Mathematical Formula 6 ] & \\ {I}_{P} = {K}_{β} β ( {V}_{REF} - {V}_{TH} ) {V}_{R 1} = {K}_{β} β ( {V}_{REF} - {V}_{TH} ) η {V}_{T} ln ( \frac{{K}_{2}}{{K}_{1}} ) & ( 6 )\end{matrix}$$

In the formula, K₁ and K₂ represent the respective aspect ratios of MOSFETs 5a and 5b, and V_{REF} is the reference voltage output from the reference voltage output terminal P_{OUT}.

The voltage source circuit unit 7 that generates the reference voltage V_{REF} based on the current I_{P} flowing from the current mirror unit 2 is connected to the third to fifth current output terminals P_{C3}, P_{C4}, P_{C5} of the current mirror unit 2. This voltage source circuit unit 7 contains a combined voltage generating unit 8 comprising two pairs of N-type MOSFETs, and two N-type MOSFETs 9, 10.

The combined voltage generating unit 8 is formed by the MOSFET pair composed of two MOSFETs 8a and 8b, and the MOSFET pair composed of two MOSFETs 8c and 8d connected in series between the input terminal P_{IN} and the output terminal P_{OUT} of the reference voltage V_{REF}. More specifically, the source terminals of MOSFETs 8a and 8b constituting one MOSFET pair are mutually connected, the gate terminal of MOSFET 8a is connected to the input terminal P_{IN}, and the gate terminal of MOSFET 8b is connected to the output terminal P_{OUT} side via the other MOSFET pair. In addition, the source terminals of MOSFETs 8c and 8d constituting the other MOSFET pair are mutually connected, the gate terminal of MOSFET 8c is connected to the input terminal P_{IN} side via one of the MOSFET pairs, and the gate terminal of MOSFET 8d is connected to the output terminal P_{OUT}.

A drain current I_{P} is generated by connecting the respective drain terminals of the three MOSFETs 8a, 8c, and 8d to the current output terminals P_{C3}, P_{C4} and P_{C5}, and in MOSFET 8b a drain current 2×I_{P} is generated due to the fact that the drain terminal is connected to the current output terminals P_{C4} and P_{C5} via MOSFETs 8c and 8d. Additionally, the gate terminals of MOSFETs 8a, 8b, 8c, and 8d are connected respectively to the current output terminals P_{C3}, P_{C4}, P_{C4}, and P_{C5}, and operate in the subthreshold-saturation region because the source voltage V_{DD} and the size of each FET have been suitably set.

A combined voltage generating unit 8 with the above configuration can generate a combined voltage with a positive temperature coefficient between the two gate terminals of each MOSFET pair in accordance with the current I_{P} provided from the current mirror unit 2. At that time, the threshold voltages that appear between the gate and source of each MOSFET will be mutually canceled out in the combined voltage that the MOSFET pairs generate.

In MOSFET 9, a drain current 3×I_{P} is supplied from the current output terminals P_{C3}, P_{C4}, and P_{C5} due to the fact that the drain terminals are connected on the side of the current output terminals P_{C3}, P_{C4}, and P_{C5} via four MOSFETs 8a, 8b, 8c, and 8d. In addition, the source terminal of MOSFET 9 is connected on the ground side via MOSFET 10. Furthermore, the gate terminal of MOSFET 9 is connected to the input terminal P_{IN} and the current output terminal P_{C3}, and MOSFET 9 operates in the subthreshold-saturation region by suitably setting the source voltage V_{DD} and the size of each FET. MOSFET 9 can generate a voltage with a negative temperature coefficient between the input terminal P_{IN} to which the gate terminal is connected and the source terminal.

The drain terminal of MOSFET 10 is connected to the source terminal of MOSFET 9, the source terminal is connected to ground, and the gate terminal is connected to the reference voltage output terminal P_{OUT}. MOSFET 10 operates as a linear resistance that can generate a voltage having a positive temperature coefficient between the drain and source because the drain current 3×I_{P} is supplied from the current output terminals P_{C3}, P_{C4} and P_{C5}, and it operates in the strong inversion-linear region.

In this case, because the reference voltage V_{REF} generated at the reference voltage output terminal P_{OUT} is obtained by adding or subtracting the gate to source voltages of MOSFETs 8a, 8b, 8c, 8d, and 9 operating in the subthreshold-saturation region to or from the drain voltage V_{R2} of MOSFET 10, it is given by Formula (7) below.

[Mathematical Formula 7]

V_{REF}=V_{R2}+V_{GS4}−V_{GS3}+V_{GS6}−V_{GS5}+V_{GS7} (7)

In this formula V_{GS3}, V_{GS4}, V_{GS5}, V_{GS6} and V_{GS7} are the respective gate to source voltages of MOSFET 8a, MOSFET 9, MOSFET 8c, MOSFET 8b, and MOSFET 8d. When one notices that the drain current flowing to MOSFET 10 of the strong inversion-linear region becomes 3×I_{P}, the drain voltage V_{R2} of MOSFET 10 is represented by Formula (8) below.

[Mathematical Formula 8]

3I_{P}=K_{β}β(V_{REF}−V_{TH})V_{R2} (8)

Therefore, the drain voltage V_{R2} is calculated by Formula (9) below using Formulas (6) and (8).

$$\begin{matrix}[ Mathematical Formula 9 ] & \\ {V}_{R 2} = \frac{3 {I}_{P}}{{K}_{β} β ( {V}_{REF} - {V}_{TH} )} \\ = \frac{3 {K}_{β} β ( {V}_{REF} - {V}_{TH} )}{{K}_{β} β ( {V}_{REF} - {V}_{TH} )} η {V}_{T} ln ( \frac{{K}_{2}}{{K}_{1}} ) \\ = η {V}_{T} ln ( \frac{{K}_{2}^{3}}{{K}_{1}^{3}} ) & ( 9 )\end{matrix}$$

As a result, when Formulas (4) and (9) are used, the following substitution can be made in Formula (7).

$$\begin{matrix}[ Mathematical Formula 10 ] & \\ \begin{matrix}{V}_{REF} = \frac{η {V}_{T} ln ( \frac{{K}_{2}^{3}}{{K}_{1}^{3}} )}{( {V}_{R 2} )} + \frac{{V}_{TH} + η {V}_{T} ln ( \frac{3 {I}_{P}}{{K}_{4} {I}_{0}} )}{( {V}_{GS 4} )} + \\ \frac{η {V}_{T} ln ( \frac{2 {K}_{3}}{{K}_{6}} )}{( {V}_{GS 6} - {V}_{GS 3} )} + \frac{η {V}_{T} ln ( \frac{{K}_{5}}{{K}_{7}} )}{( {V}_{GS 7} - {V}_{GS 5} )} \\ = \frac{{V}_{TH} + η {V}_{T} ln ( \frac{3 {I}_{P}}{{K}_{4} {I}_{0}} )}{( {V}_{GS 4} )} + \\ \frac{η {V}_{T} ln ( \frac{2 {K}_{2}^{3} {K}_{3} {K}_{5}}{{K}_{1}^{3} {K}_{6} {K}_{7}} )}{( {V}_{R 2} + {V}_{GS 6} - {V}_{GS 3} + {V}_{GS 7} - {V}_{GS 5} )}\end{matrix} & ( 10 )\end{matrix}$$

In this formula, K₃ to K₇ represent the aspect ratios of MOSFETs 8a, 9, 8c, 8b, and 8d. Thus, the reference voltage V_{REF} depends on the value obtained by scaling the gate to source voltage V_{GS4} of MOSFET 9 and the thermal voltage V_{T} with transistor sizes K₁ to K₇. The third and fourth terms of Formula (10) above indicate voltages across the gate terminals of the two MOSFET pairs of the combined voltage generating unit 8.

Next, the temperature properties of the reference voltage V_{REF} will be considered. In general, the temperature dependence of the threshold voltage V_{TH} and the mobility μ are expressed by Formulas (11) and (12) below.

$$\begin{matrix}[ Mathematical Formula 11 ] & \\ {V}_{TH} = {V}_{TH 0} - κ T & ( 11 ) \\ [ Mathematical Formula 12 ] & \\ μ = {{μ}_{0} ( \frac{{T}_{0}}{T} )}^{m} & ( 12 )\end{matrix}$$

In this case, V_{TH0} represents the threshold voltage at absolute zero temperature, κ represents the threshold voltage temperature coefficient, T represents the absolute temperature, μ₀ represents the mobility at T₀, and m represents the temperature coefficient of mobility. Thereby, the derivative temperature coefficient of the reference voltage V_{REF} is expressed by Formula (13) below.

$$\begin{matrix}[ Mathematical Formula 13 ] & \\ \frac{d {V}_{REF}}{d T} = \frac{d {V}_{TH}}{d T} + \frac{d }{d T} ( η {V}_{T} ln ( \frac{3 {I}_{P}}{{K}_{4} {I}_{0}} ) ) + \frac{d }{d T} ( η {V}_{T} ln ( \frac{2 {K}_{2}^{3} {K}_{3} {K}_{5}}{{K}_{1}^{3} {K}_{6} {K}_{7}} ) ) & ( 13 )\end{matrix}$$

When Formula (13) is rearranged using Formula (6), the relationship shown in Formula (14) below is obtained.

$$\begin{matrix}[ Mathematical Formula 14 ] & \\ \frac{d {V}_{REF}}{d T} = - κ + \frac{η {V}_{T}}{T} ln ( \frac{3 {K}_{β} β ( {V}_{REF} - {V}_{TH} )}{{K}_{4} {I}_{0}} η {V}_{T} ln ( \frac{{K}_{2}}{{K}_{1}} ) ) + η {V}_{T} ( \frac{1}{{V}_{REF} - {V}_{TH}} \frac{d {V}_{REF}}{d T} + \frac{κ}{{V}_{REF} - {V}_{TH}} - \frac{1}{T} ) + \frac{η {V}_{T}}{T} ln ( \frac{2 {K}_{2}^{3} {K}_{3} {K}_{5}}{{K}_{1}^{3} {K}_{6} {K}_{7}} ) & ( 14 )\end{matrix}$$

In the formula, when either ηV_{T} or the difference between the reference voltage V_{REF} and the threshold voltage at absolute zero temperature V_{TH0} is sufficiently smaller than κT, i.e., it can be assumed that ηV_{T}<<κT, V_{REF}−V_{TH0}<<κT, Formula (15) below is obtained from Formula (14) above.

$$\begin{matrix}[ Mathematical Formula 15 ] & \\ \frac{d {V}_{REF}}{d T} = - κ + \frac{η {V}_{T}}{T} ln ( \frac{κ T}{{V}_{T}} \frac{6 η {K}_{β} {K}_{2}^{3} {K}_{3} {K}_{5}}{( η - 1 ) {K}_{1}^{3} {K}_{4} {K}_{6} {K}_{7}} ln ( \frac{{K}_{2}}{{K}_{1}} ) ) & ( 15 )\end{matrix}$$

Therefore, by setting each aspect ratio K, which is a circuit design parameter, as in Formula (16) below, it is possible to make the temperature coefficient of the reference voltage V_{REF} equal to zero.

$$\begin{matrix}[ Mathematical Formula 16 ] & \\ \frac{η {V}_{T}}{T} ln ( \frac{κ T}{{V}_{T}} \frac{6 η {K}_{β} {K}_{2}^{3} {K}_{3} {K}_{5}}{( η - 1 ) {K}_{1}^{3} {K}_{4} {K}_{6} {K}_{7}} ln ( \frac{{K}_{2}}{{K}_{1}} ) ) = κ & ( 16 )\end{matrix}$$

The reference voltage V_{REF} at this time is expressed by Formula (17) below in a case where ηV_{T}<<κT, and V_{REF}−V_{TH0}<<κT.

$$\begin{matrix}[ Mathematical Formula 17 ] & \\ {V}_{REF} = {V}_{TH 0} + η {V}_{T} ln ( 1 + \frac{{V}_{REF} - {V}_{TH}}{κ T} ) \\ = {V}_{TH 0} + η {V}_{T} \frac{{V}_{REF} - {V}_{TH}}{κ T} \\ = {V}_{TH 0} & ( 17 )\end{matrix}$$

According to the formula, it is clear that the reference voltage V_{REF} is essentially equal to the threshold voltage V_{TH0} at absolute zero temperature. In addition, the current I_{P} generated by the current mirror unit 2 at this time is expressed from Formula (16) in Formulas (18) and (19) below, and becomes a current referring to the subthreshold current pre-coefficient I₀.

$$\begin{matrix}[ Mathematical Formula 18 ] & \\ {I}_{P} = {β ( η {V}_{T} )}^{2} ln ( \frac{κ T}{{V}_{T}} \frac{6 η {K}_{β} {K}_{2}^{3} {K}_{3} {K}_{5}}{( η - 1 ) {K}_{1}^{3} {K}_{4} {K}_{6} {K}_{7}} ln ( \frac{{K}_{2}}{{K}_{1}} ) ) ln ( \frac{{K}_{2}}{{K}_{1}} ) = {AI}_{0} & ( 18 ) \\ [ Mathematical Formula 19 ] & \\ A = \frac{{K}_{β} {η}^{2}}{η - 1} ln ( \frac{κ T}{{V}_{T}} \frac{6 η {K}_{β} {K}_{2}^{3} {K}_{3} {K}_{5}}{( η - 1 ) {K}_{1}^{3} {K}_{4} {K}_{6} {K}_{7}} ln ( \frac{{K}_{2}}{{K}_{1}} ) ) ln ( \frac{{K}_{2}}{{K}_{1}} ) & ( 19 )\end{matrix}$$

From the above discussion, the reference voltage V_{REF} generated by the reference voltage generation circuit 1 becomes one wherein the voltage having a positive temperature coefficient generated by the two MOSFET pairs of the combined voltage generating unit 8, the voltage having a positive temperature coefficient generated by MOSFET 10, and the voltage having a negative temperature coefficient generated by MOSFET 9 are combined, and this enables setting conditions wherein the temperature coefficient becomes zero because these temperature coefficients are canceled out.

According to the reference voltage generation circuit 1 disclosed above, a current I_{P} determined by the circuit properties of the current mirror unit 2, the reference voltage output value V_{REF}, and the properties of MOSFET 6b that acts as a linear resistance, is set at each of the five current output terminals P_{C1}, P_{C2}, P_{C3}, P_{C4}, and P_{C5} of the current mirror unit 2, and by generating current I_{P} at the drain terminals of the MOSFET pairs of the combined voltage generating unit 8 from the third to fifth current output terminals P_{C3}, P_{C4}, and P_{C5}, or a current whereon the current I_{P} is superposed, a composite voltage V_{GS6}−V_{GS3}+V_{GS7}−V_{GS5} with a positive temperature coefficient is generated between the input terminal P_{IN} of the combined voltage generating unit 8 and the reference voltage output terminal P_{OUT}. In addition, because the current 3×I_{P} is generated from the third to fifth current output terminals P_{C3}, P_{C4}, and P_{C5} at the drain terminal of MOSFET 9, a voltage V_{GS4} having negative temperature properties is output between the drain terminal and the source terminal of MOSFET 9. Thus, by adjusting the circuit design parameters such as the MOSFET aspect ratio, etc., it is possible to output a temperature independent constant voltage to the reference voltage output terminal P_{OUT}. At this time, because the MOSFET pairs contributing to the generation of the reference voltage V_{REF} and MOSFET 9 are operating in the same operating regions, a mismatch in operating parameters is unlikely to occur, and because the properties among the MOSFETs with respect to design parameters do not vary greatly, it is possible to generate a reference voltage V_{REF} that is stable in relation to temperature changes.

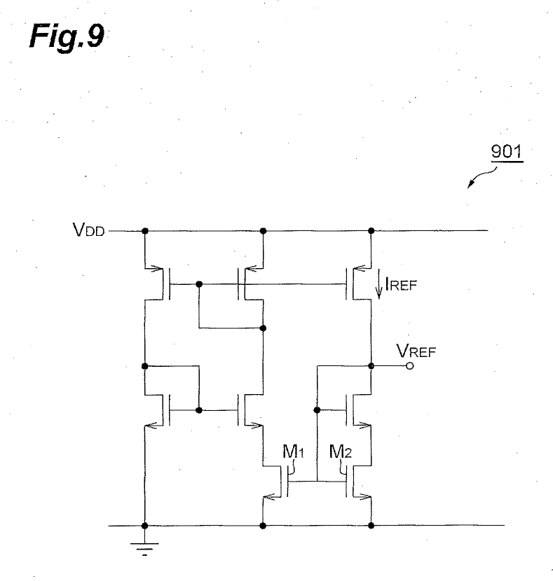

Additionally, even if the output current I_{F} of the current mirror unit 2 varies due to fluctuations in the source voltage V_{DD}, etc., the reference voltage generation circuit enables the generation of a stable reference voltage V_{REF}. The prior art reference voltage generation circuit 901 shown in FIG. 9 has a structure wherein a MOSFET M₁ operating in the strong inverse-linear region and MOSFET M₂ operating in the strong inverse-saturation region are connected to two current output paths of the current mirror unit. The reference voltage V_{REF} generated by this reference voltage generation circuit 901 fluctuates according to the square root of the output current I_{REF} of the current mirror unit 2. On the other hand, as one can see from Formula (17), the reference voltage V_{REF} in the present embodiment is generated as a stable voltage that is independent of the current I_{P}.

In addition, by also providing MOSFET 10 that operates as a linear resistance and can generate a voltage having a positive temperature coefficient, the output of a constant reference voltage V_{REF} in relation to temperature becomes possible even if the temperature coefficient of the combined voltage generating unit 8 is small, and this enables the scale of the circuit as a whole to be reduced.

Moreover, MOSFETs 8a, 8b, 8c, and 8d constituting the MOSFET pairs and MOSFET 9 operate in the subthreshold region since the gate terminals thereof are each connected to one of the third to fifth current output terminals P_{C3}, P_{C4}, and P_{C5}, and as a result it is not only possible to reduce the power consumption of the circuit, but by connecting each gate terminal to the output of the current mirror unit 2, each can easily be matched to the operating regions of the MOSFETs.

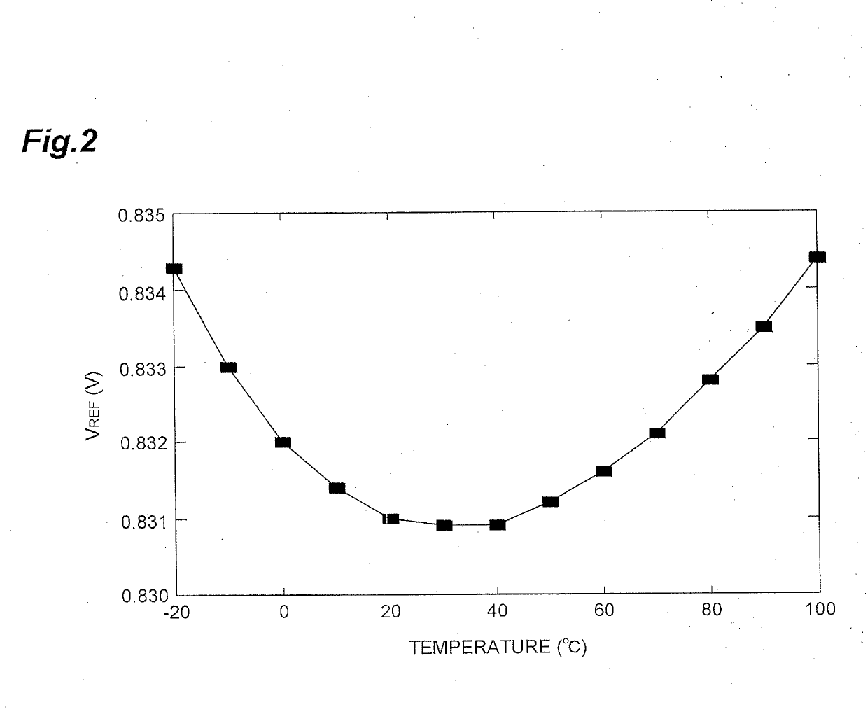

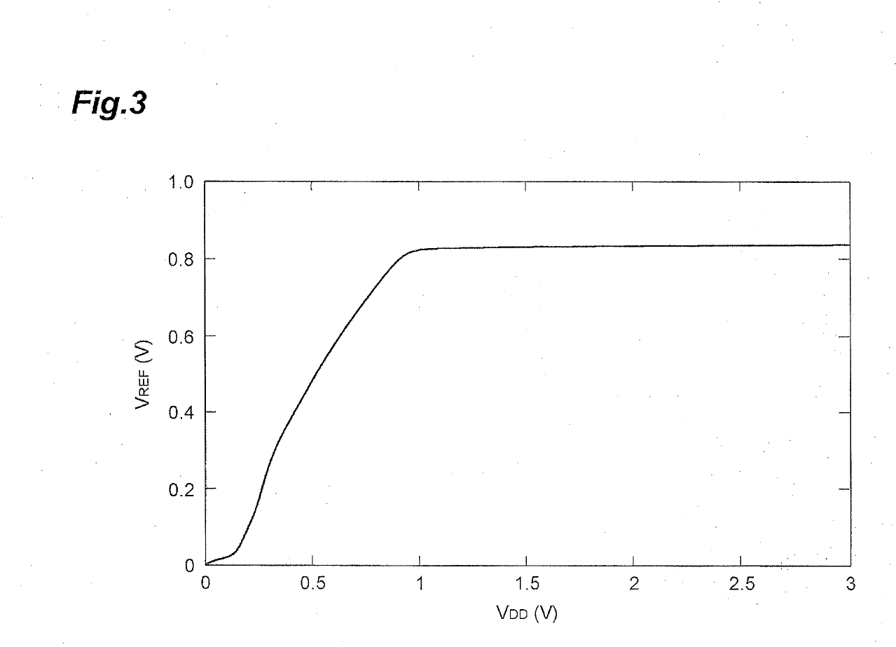

FIG. 2 is a graph showing the results of a simulation of temperature properties of the reference voltage V_{REF} generated by the reference voltage generation circuit 1. FIG. 3 is a graph showing the results of a simulation of the dependency of the reference voltage V_{REF} on the source voltage V_{DD}. At this time the size of each FET was set as follows: K₁=20, K₂=36, K₃=110, K₄=4, K₅=110, K₆=4, and K₇=4. From these results one can see that even if the temperature fluctuates in a range from −20° C. to 100° C., a reference voltage V_{REF} averaging 830 mV is output within 0.4% error and a temperature independent, stable reference voltage is generated. Moreover, if the source voltage V_{DD} is approximately 1 V or higher, it is clear that a stable reference voltage can be generated even if the source voltage changes.

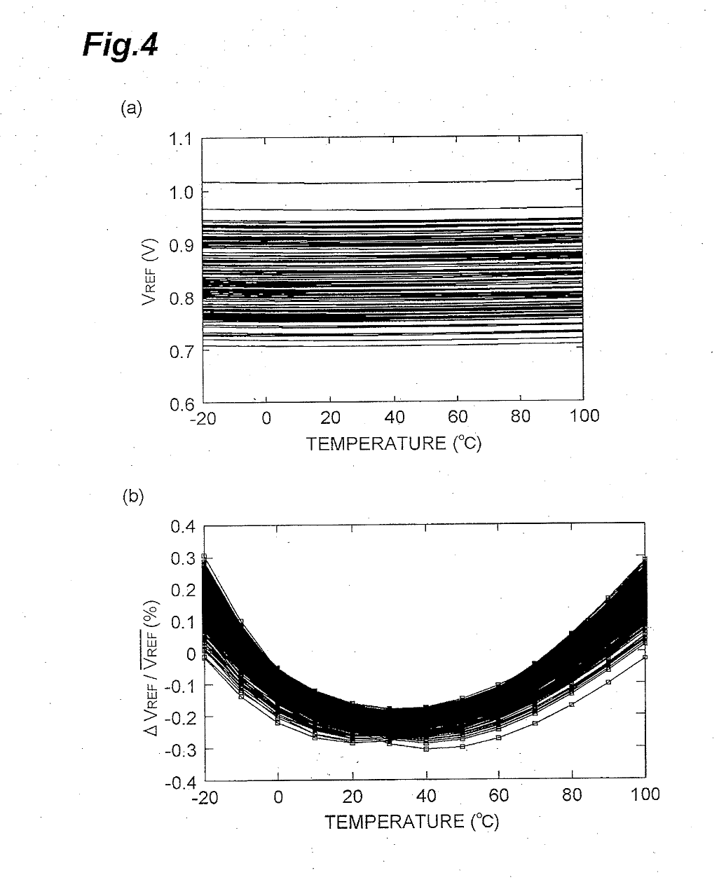

FIG. 4 shows the results of a simulation of the temperature properties of the reference voltage V_{REF} when variations due to transistor process variations is taken into consideration. FIG. 4(a) is a graph showing the temperature properties of the reference voltage V_{REF}, and FIG. 4(b) is a graph showing the rate of change of the reference voltage V_{REF} in relation to temperature ΔV_{REF}/V_{REF}. Because the reference voltage generation circuit 1 is a threshold voltage-referring reference voltage source, the absolute value per se of the reference voltage V_{REF} will change due to process variations, but it is clear that the fluctuation in relation to temperature is held to a sufficiently low level of within ±0.4%.

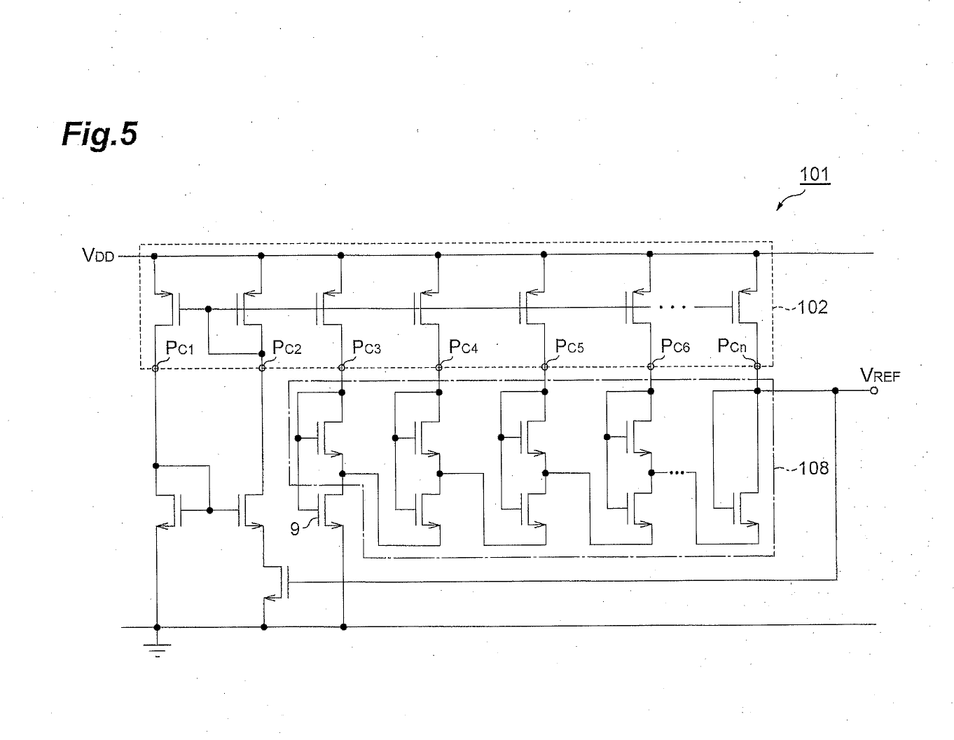

The present invention is not limited to the embodiment disclosed above. For example, the present invention can have a modified form such as that shown in FIG. 5. In other words, the reference voltage generation circuit 101 that is a modified example of the present invention shown in FIG. 5 comprises a current mirror unit 102 having n (wherein n is an integer of 4 or more) P-type MOSFETs and generating a current at the current output terminals P_{C1} to P_{Cn}, a combined voltage generating unit 108 connected to the current output terminals P_{C3} to P_{Cn}, and wherein n−3 groups of MOSFET pairs are connected in series, and MOSFET 9 connected to the current output terminals P_{C3} to P_{Cn} via the combined voltage generating unit 108. The number of steps n of the mirror current unit 102 is established as needed according to the value of the source voltage V_{DD} and the size of each FET. In accordance with such a reference voltage generation circuit 101, it is possible to generate a reference voltage V_{REF} that is stable in relation to temperature by combining a voltage having a positive temperature coefficient generated by the combined voltage generating unit 108 and a voltage having a negative temperature coefficient generated by MOSFET 9. In particular, by connecting the source terminal of MOSFET 9 directly to ground, it is possible to cancel out the substrate bias effect in MOSFET 9, so fluctuations in the reference voltage V_{REF} can be reduced even more.

N-type transistors were used for MOSFETs 5a, 5b, 6b, 8a, 8b, 8c, 8d, 9, and 10 of the reference voltage generation circuit 1, but the circuit can also be realized with a circuit structure using P-type transistors.

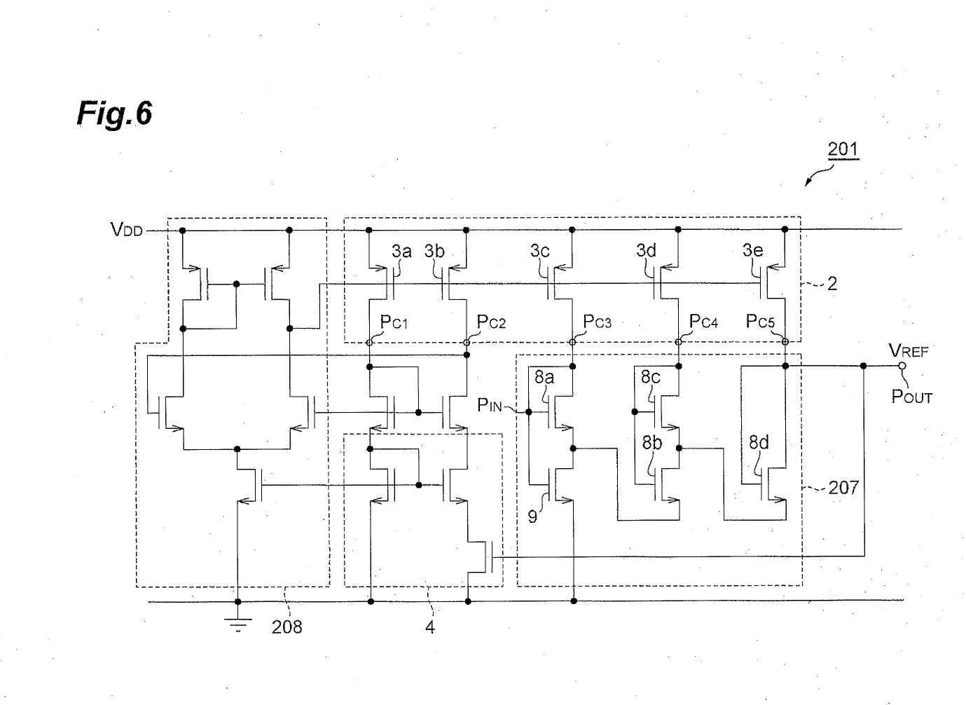

In addition, the present invention can be used in a modified form such as the one shown in FIG. 6. More specifically, the reference voltage generation circuit 201 shown in that drawing can also comprise an op-amp 208 so that a stable current I_{P} can be generated in the current mirror unit 2. In this op-amp 208, two input terminals are connected to the drain terminals of MOSFETs 3a and 3b, respectively, and the output terminals are connected in common to the gate terminals of MOSFETs 3a to 3e. By such a structure, even if the source voltage V_{DD} fluctuates, because the drain voltages of MOSFETs 3a and 3b are stably held at the same value, it is possible to stabilize the current I_{P} and obtain low voltage in the circuit. Additionally, in the reference voltage generation circuit 201, MOSFET 10 that operates in the strong inversion-linear region can also be eliminated. In other words, if MOSFET 10 is present, the source terminal of MOSFET 9 becomes greater than the ground voltage, and the threshold voltage of MOSFET 9 will vary slightly due to the substrate bias effect. When minimization of such an effect is desired, the source terminal of MOSFET 9 can be connected directly to ground.

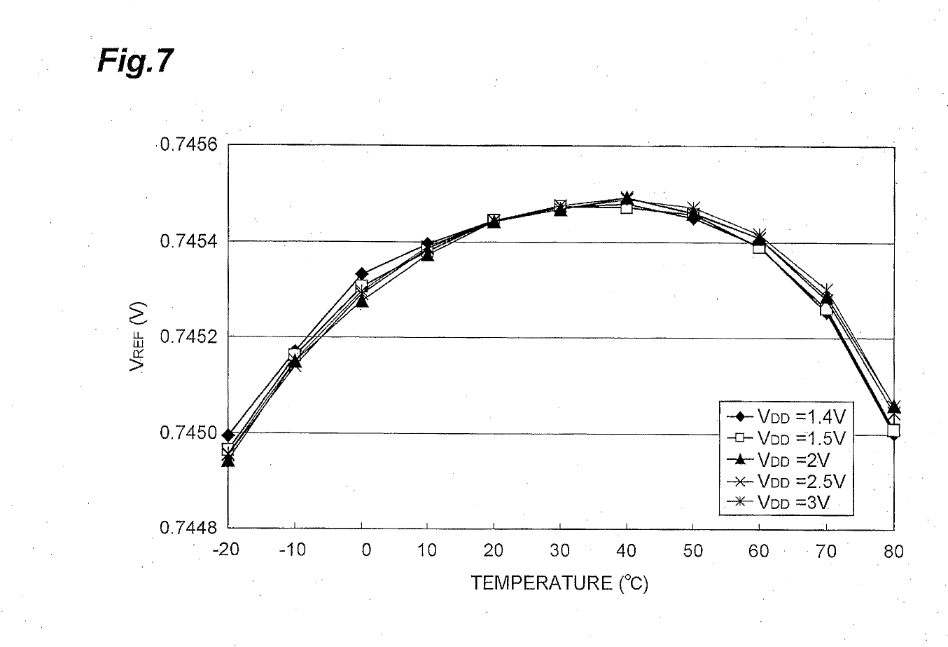

FIG. 7 is a graph showing the measurement results of the temperature properties of the reference voltage V_{REF} generated by the reference voltage generation circuit 201 in a case where the source voltage V_{DD} is altered. For these measurement results, a reference voltage generation circuit 201 was actually fabricated on an LSI chip and used as the object of measurement. Based on these results, one can clearly see that a temperature independent, stable reference voltage was generated even when the source voltage V_{DD} was altered in various ways.

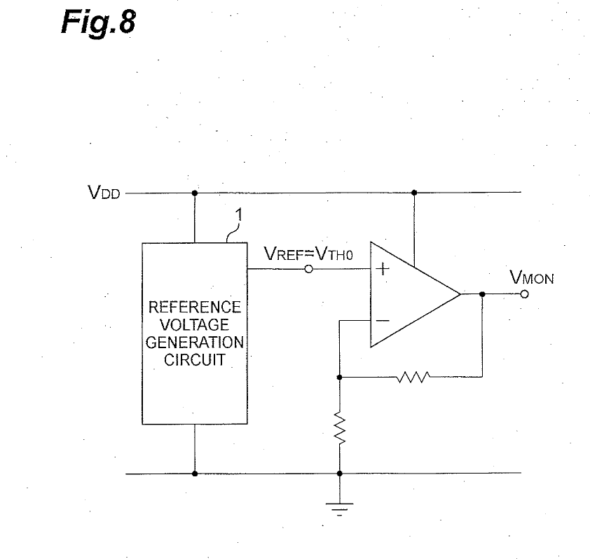

Finally, an application example of a reference voltage generation circuit 1 will be described. As shown in FIG. 8, the reference voltage generation circuit 1 can be used as a three-terminal regulator circuit for monitoring these threshold voltages in transistors caused by process variations. In other words, because the reference voltage V_{REF}, which is the output of the reference voltage generation circuit 1, expresses the threshold voltage V_{TH0}, process variations can be detected by monitoring this reference voltage with a monitor voltage V_{MON}.

The transistors constituting the field effect transistor pair and the second field effect transistor preferably operate in the subthreshold region by connection of each respective gate terminal to the third to Nth current output terminals. In such a case, it is possible to reduce power consumption of the circuit through operation of the field effect transistor pair and the second field effect transistor in the subthreshold region, and the operating region of each transistor can be easily matched by connecting the gate terminals of each to the output of the current mirror unit.

Furthermore, it is also preferable to provide a third field effect transistor that functions as linear resistance wherein the drain terminal thereof is connected to the second field effect transistor source terminal, the source terminal thereof is connected to ground, and the gate terminal thereof is connected to the reference voltage output terminal. By so doing, because a voltage having a relatively high positive temperature coefficient is generated between the drain terminal and the source terminal of the third field effect transistor, output of a constant reference voltage is possible even if the thermal coefficient of the combined voltage generating unit is small, and the scale of the circuit as a whole can be reduced thereby.

### INDUSTRIAL APPLICABILITY

As an application of a reference voltage generation circuit, the present invention generates a stable reference voltage with respect to manufacturing process variations by matching the operating regions of MOSFETs contributing to generation of the reference voltage.

1. A reference voltage generation circuit comprising:
a current mirror unit supplied with a source voltage and generating a current at first to Nth (wherein N is an integer of 4 or more) current output terminals;
a first field effect transistor operating as a linear resistance, and having a drain terminal connected to the second current output terminal side, a source terminal connected to ground side, and a gate terminal connected to a reference voltage output terminal;
a combined voltage generating unit having one or more field effect transistor pairs in which currents are generated at drain terminals from any of the third to Nth current output terminals, source terminals are mutually connected and a combined voltage with a positive temperature coefficient is generated between gate terminals, the field effect transistor pairs being connected in series between an input terminal and the reference voltage output terminal; and
a second field effect transistor in which current is generated at a drain terminal from the third current output terminal, a gate terminal is connected to the input terminal of the combined voltage generating unit, a source terminal is connected on the ground side, and a voltage with a negative temperature coefficient is generated between the gate terminal and source terminal.

2. The reference voltage generation circuit according to claim 1, wherein the transistors constituting the field effect transistor pairs and the second field effect transistor operate in a subthreshold region by the respective gate terminals thereof being connected to the third to Nth current output terminals.

3. The reference voltage generation circuit according to claim 1, further comprising a third field effect transistor operating as a linear resistance, and having a drain terminal connected to the source terminal of the second field effect transistor, a source terminal connected to ground, and a gate terminal connected to the reference voltage output terminal.
